(19) United States
(12) Patent Application Publication
(10) Pub. No.: US 2006/0158112 A1
(43) Pub. Date: Jul. 20, 2006

(54) Plasma display panel

(76) Inventors: Min Hur, Suwon-si (KR); Jae-Rok Kim, Suwon-si (KR)

Correspondence Address: CHRISTIE, PARKER & HALE, LLP, PO BOX 7068, PASADENA, CA, 91109-7068, US

(21) Appl. No.: 11/196,619

(22) Filed: Aug. 2, 2005

(30) Foreign Application Priority Data
Jan. 20, 2005 (KR) 10-2005-0005295

(51) Int. Cl. H01J 17/49

(52) U.S. Cl. 313/582; 313/586; 313/583

(57) ABSTRACT

A PDP capable of reducing a discharge firing voltage and improving luminescence efficiency using an opposing electrode structure is presented. The PDP includes a first substrate and a second substrate opposite the first, leaving a space in between where a plurality of partitioned discharge cells are formed, phosphor layers formed in the discharge cells, address electrodes formed between the first and second substrates, first and second electrodes formed between the first and second substrates extending orthogonal to the address electrodes and alternately arranged among adjacent discharge cells and each commonly used by the adjacent discharge cells, and dielectric layers formed to cover outer surfaces of the address electrodes and the first and second electrodes. Each of the address electrodes has a protruding portion that protrudes into the discharge cells and is commonly used by adjacent discharge cells sharing the first or second electrodes.

### CROSS REFERENCE TO RELATED APPLICATION

This application claims priority to and the benefit of Korean Patent Application No. 10-2005-0005295, filed on Jan. 20, 2005 in the Korean Intellectual Property Office, the entire content of which is incorporated herein by reference

### FIELD OF THE INVENTION

The present invention relates to a plasma display panel, and more particularly, to a plasma display panel capable of reducing a discharge firing voltage and of improving luminescence efficiency.

### BACKGROUND OF THE INVENTION

Plasma display panels (PDP) include surface discharge PDP devices and opposing electrode discharge PDP devices. In surface discharge structures, a pair of electrodes which are involved in a sustain discharge are formed on a same plane in a direction perpendicular to a front and rear substrate. Therefore, the sustain discharge occurs between two portions on the same plane, which correspond to the pair of electrodes and are positioned away from each other. However, in opposing electrode structures, the pair of electrodes which are involved in the sustain discharge are disposed in an opposite direction from each other. Therefore, the sustain discharge occurs between the opposing surfaces of the pair of electrodes.

A three-electrode surface discharge type PDP includes one substrate having sustain electrodes and scan electrodes on a surface of the substrate and another substrate having address electrodes that are arranged perpendicular to the sustain and the scan electrodes. A space formed between the substrates is filled with discharge gas and sealed. The discharge of the PDP is determined by the discharge of the address electrodes and the scan electrodes that are independently controlled. A sustain discharge for displaying an image is generated by the sustain electrodes and the scan electrodes which are formed on the same substrate.

In general, the PDP generates visible rays using a glow discharge, and visible rays generated by the glow discharge reach the human eye through several stages. When the glow discharge is generated, excited gas is generated by the collision between electrons and gas, and ultraviolet rays are generated by the excited gas. The ultraviolet rays collide with a phosphor material in discharge cells to generate visible light, and the visible light reaches the human eye through a transparent front substrate. Input power applied to the sustain and scan electrodes is considerably reduced through these stages.

The glow discharge is generated by applying a voltage higher than a discharge firing voltage between the two electrodes. A considerably high voltage is needed to generate this glow discharge. Once the glow discharge is generated, a voltage distribution between a cathode and an anode is distorted due to a space charge effect occurring in a dielectric layer around the cathode and the anode. A cathode sheath region is formed in the vicinity of the cathode where most of the voltage applied to the two electrodes for generating the discharge is consumed. An anode sheath region is formed in the vicinity of the anode where a portion of the voltage is consumed. A positive column region is formed between the two regions where the voltage is hardly consumed. Electron heating efficiency depends on a secondary electron coefficient of an MgO protective film formed on the surface of the dielectric layer in the cathode sheath region. Most of the input power is used for electron heating in the positive column region.

Vacuum ultraviolet rays emitting visible light by a collision with the phosphor material are generated when xenon (Xe) gas is transferred from an excitation state to a ground state. The excitation state of xenon (Xe) is generated by a collision between xenon (Xe) gas and electrons. Therefore, in order to raise the ratio of the input power used for generating visible light, the number of collisions between xenon (Xe) gas and electrons has to be increased. In order to increase the number of collisions between xenon (Xe) gas and electrons, the electron heating efficiency must be increased.

In the cathode sheath region, most of the input power is consumed, but the electron heating efficiency is low. In the positive column region, a small amount of input power is consumed, and the electron heating efficiency is very high. Therefore, it is possible to obtain high luminescence efficiency by increasing the positive column region (discharge gap).

The ratio (E/n) is the ratio of an electric filed E applied to both ends of the discharge gap (positive column region) to a gas density n of the gas filling the gap. The ratio of electrons consumed for xenon excitation (Xe*) to all electrons including those consumed for xenon excitation (Xe*), for xenon ionization (Xe⁺), for neon excitation (Ne*), and for neon ionization (Ne⁺) is increased with the ratio (E/n). In addition, at the same ratio (E/n), as the electron energy is reduced, the partial pressure of xenon (Xe) is increased. Accordingly, when the partial pressure of xenon (Xe) is increased, the ratio of electrons consumed for the excitation of xenon (Xe) is increased among the electrons consumed for the xenon excitation (Xe*), the xenon ionization (Xe⁺), the neon excitation (Ne*), and the neon ionization (Ne⁺). This makes it possible to improve luminescence efficiency.

As described above, electron heating efficiency is improved by the increase in the positive column region. In addition, the ratio of electrons consumed for the xenon excitation (Xe*) is raised by the increase in the partial pressure of xenon (Xe). Therefore, both the increase in the positive column region and the increase in the partial pressure of xenon (Xe) make it possible to raise electron heating efficiency, which results in an improvement in luminescence efficiency.

However, both the increase in the positive column region and the increase in the partial pressure of xenon (Xe) cause an increase in gas discharge voltage, which results in an increase in the manufacturing costs of the PDP.

Therefore, it is necessary to increase the positive column region and the partial pressure of xenon (Xe) at a low discharge firing voltage, in order to improve luminescence efficiency.

A discharge firing voltage required for the opposing electrode structure is lower than a discharge firing voltage required for a surface discharge structure when the same discharge gap and pressure are used for the two structures.

### SUMMARY OF THE INVENTION

Embodiments of the invention provide a PDP capable of reducing a discharge firing voltage and improving luminescence efficiency using an opposing electrode structure.

According to an aspect of the invention, a PDP includes a first substrate and a second substrate located opposite each other with a space in between, where a plurality of partitioned discharge cells are formed. The PDP further includes phosphor layers that are formed in the discharge cells, address electrodes that are formed along a direction between the first substrate and the second substrate, first electrodes and second electrodes that are formed between the first substrate and the second substrate extending orthogonal to the address electrodes and alternately arranged between adjacent discharge cells, and each of which being commonly used by the adjacent discharge cells, and dielectric layers that are formed to cover outer surfaces of the address electrodes, the first electrodes, and the second electrodes. Each of the address electrodes has a protruding portion that protrudes in the extending direction of the second electrode and that is commonly used by adjacent discharge cells sharing the first electrode or the second electrode.

In one embodiment, the PDP of the invention further includes a first barrier rib layer that is provided on the first substrate to form a plurality of discharge spaces, and a second barrier rib layer that is provided on the second substrate to form a plurality of discharge spaces corresponding to the plurality of discharge spaces formed on the first substrate. In addition, in one embodiment, the address electrodes, the first electrodes, and the second electrodes are arranged between the first barrier rib layer and the second barrier rib layer.

Furthermore, in the above-mentioned structure, a scanning pulse may be applied to the second electrodes in an addressing period, and the protruding portion of the address electrode may be commonly used by adjacent discharge cells sharing the second electrode.

In some embodiments, a protective film may be formed on the dielectric layers, and the protective film may have a non-visible-light-transmission characteristic.

In some embodiments, the address electrodes are arranged close to the first substrate, and the first electrodes and the second electrodes are arranged close to the second substrate. In addition, in some embodiments, a gap is formed between an imaginary line which an edge of the address electrode facing the second substrate forms and an imaginary line which edges of the first and second electrodes facing the first substrate form.

In some embodiments, in the direction perpendicular to the substrates, a thickness of the address electrode is smaller than a thickness of the first electrode, and the thickness of the address electrode is smaller than a thickness of the second electrode.

In some embodiments, the volume of each discharge space formed by the second barrier rib layer is larger than the volume of each discharge space formed by the first barrier rib layer.

In some embodiments, the first barrier rib layer includes first barrier rib members that are formed parallel to the address electrodes and second barrier rib members that intersect the first barrier rib members, and the second barrier rib layer includes third barrier rib members that are formed parallel to the address electrodes and fourth barrier rib members that are formed to intersect the third barrier rib members.

In some embodiments, the phosphor layers include a first phosphor layer that is formed on the first substrate of the discharge cells, and a second phosphor layer that is made of the same phosphor material as the first phosphor layer, and that is formed on the second substrate of the discharge cells. In addition, in some embodiments, the thickness of the first phosphor layer is larger than that of the second phosphor layer.

The first and second electrodes may be sustain and scan electrodes and the first and second substrates may be rear and front substrates in a PDP. As described above, according to the PDP of the invention, sustain, scan, and address electrodes are provided between the rear and front substrates. The sustain and scan electrodes are alternately arranged on two sides of adjacent discharge cells and are commonly used by adjacent discharge cells. Protruding portions of the address electrodes are also commonly used by adjacent discharge cells. Compared to a conventional address electrode structure in which protruding portions are separately provided in each discharge cell, the structure of the invention secures a larger aperture ratio for the discharge cell, and improves luminescence efficiency.

Moreover, according to the PDP of the invention, because the sustain electrodes and the scan electrodes are arranged in an opposing electrode structure, it is possible to reduce the discharge firing voltage below the discharge firing voltage of a conventional surface discharge structure.

### BRIEF DESCRIPTION OF THE DRAWINGS

FIG. 1 is a partially exploded perspective view showing a PDP according to an embodiment of the invention.

FIG. 2 is a partial plan view schematically illustrating the structure of discharge cells and electrodes of the PDP according to the embodiment of FIG. 1.

FIG. 3 is a cross-sectional view taken along the line III-III of the PDP shown in FIG. 1.

FIG. 4 is a cross-sectional view taken along the line IV-IV of the PDP shown in FIG. 1.

FIG. 5 is a partial perspective view schematically illustrating the structure of electrodes of the PDP according to the embodiment of FIG. 1.

### DETAILED DESCRIPTION

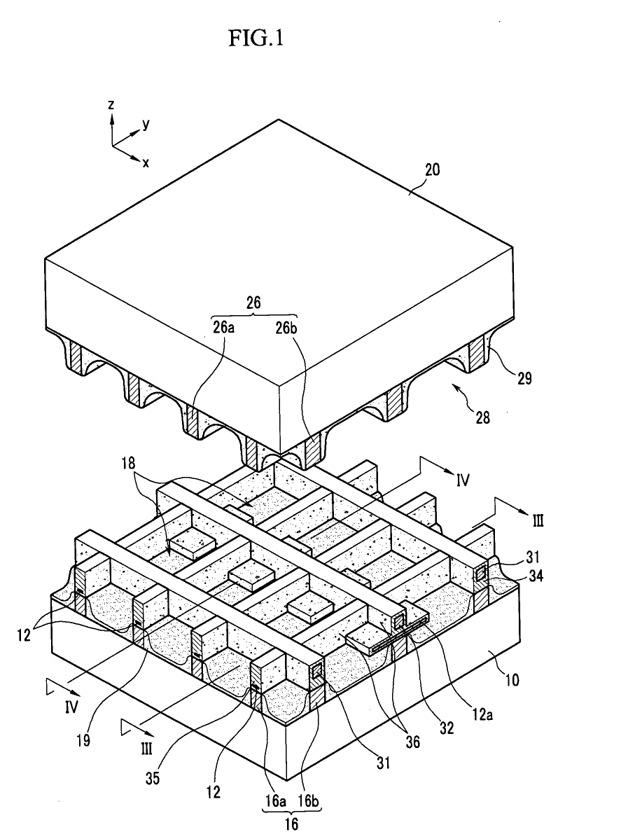

FIG. 1 is a partially exploded perspective view showing a PDP in accordance with a first embodiment of the invention. The PDP includes a first substrate 10 (hereinafter, referred to as a “rear substrate”) and a second substrate 20 (hereinafter, referred to as a “front substrate”) that are arranged opposite to each other with a predetermined gap in between. The space between the rear and front substrates 10, 20 forms a discharge space. A plurality of discharge cells 17 are formed by partitioning the discharge space between the rear substrate 10 and the front substrate 20. Each discharge cell 17, is formed by a combination of discharge spaces 18 and discharge spaces 28. The discharge space is partitioned by a first barrier rib layer 16 (hereinafter, referred to as a “rear-plate barrier rib”) and a second barrier rib layer 26 (hereinafter, referred to as a “front-plate barrier rib”). Phosphor layers 19, 29 that absorb vacuum ultraviolet rays to emit visible light are formed in the discharge cells 17. Discharge gas, for example xenon (Xe) or neon (Ne), fills the discharge cells 17 to generate vacuum ultraviolet rays by a plasma discharge.

The rear-plate barrier rib 16 projects from the rear substrate 10 toward the front substrate 20. The front-plate barrier rib 26 projects from the front substrate 20 toward the rear substrate 10. The rear-plate barrier ribs 16 form a plurality of discharge spaces adjacent to the rear substrate 10 where the back discharge spaces 18 are formed. The front-plate barrier ribs 26 form a plurality of discharge spaces adjacent to the front substrate 20 where the front discharge spaces 28 are formed. One discharge cell 17 is formed by the discharge spaces on the substrates 10, 20 opposite each other. In the following written description, as long as the front discharge space 28 and the back discharge space 18 are not specifically designated, the discharge cells 17 indicate one discharge cell formed by a combination of two discharge spaces.

In some embodiments, the volume of the front discharge space 28, formed by the front-plate barrier ribs 26 may be larger than the volume of the back discharge space 18 formed by the back-plate barrier ribs 16. This difference between the back and front volumes enables visible light generated in the discharge cells 17 to effectively pass through the front substrate 20.

The rear-plate barrier rib 16 and the front-plate barrier rib 26 can be formed such that the discharge cells 17 have rectangular or hexagonal shapes. In the embodiment shown, the discharge cells 17 have rectangular shapes. In addition, the rear-plate barrier rib 16 includes first barrier rib members 16a and second barrier rib members 16b which are formed on the rear substrate 10. In the embodiment shown, the first barrier rib members 16a extend in one direction (y-axis direction of the figure), and the second barrier rib members 16b extend in a direction orthogonal to the first barrier members 16a (x-axis direction of the figure). As a result, the back discharge spaces 18 are partitioned as discharge spaces on the rear substrate 10. The front-plate barrier rib 26 is composed of third barrier rib members 26a and fourth barrier members 26b which are formed on the front substrate 20. The third barrier rib members 26a are formed corresponding to the first barrier rib members 16a, and project toward the rear substrate 10. The fourth barrier rib members 26b are formed corresponding to the second barrier rib members 16b, and project toward the rear substrate 10. Therefore, the third and fourth barrier rib members 26a, 26b of the front-plate barrier ribs 26 intersect each other, forming the front discharge spaces 28 on the front substrate 20, corresponding to the back discharge spaces 18 formed on the rear substrate 10.

The phosphor layers 19, 29 are formed in the discharge cells 17, respectively, as described above. That is, the phosphor layers 19, 29 are composed of a first phosphor layer 19 formed in the back discharge spaces 18 on the rear substrate 10 and a second phosphor layer 29 formed in the front discharge spaces 28 on the front substrate 20.

The first phosphor layer 19 is formed on inner surfaces of the first and second barrier rib members 16a, 16b and on the rear substrate 10 in the back discharge space 18. The second phosphor layer 29 is formed on inner surfaces of the third and fourth barrier rib members 26a, 26b and on the surface of the rear substrate 10 in the discharge cells 28. The combination of back discharge spaces 18 formed by the rear-plate barrier ribs 16 and the front discharge spaces 28 formed by the front-plate barrier ribs opposite the back discharge spaces 18, constitutes one partitioned discharge cell 17. Therefore, the first phosphor layer 19 and the second phosphor layer 29 formed in one discharge cell 17 generate visible light of the same color.

The first phosphor layer 19 may be formed by applying a phosphor material on the rear substrate 10 having the rear-plate barrier ribs 16. Alternatively, the first phosphor layer 19 may be formed by etching the rear substrate 10 into the shape of the back discharge spaces 18 and by applying a phosphor material on the etched surface. Similarly, the second phosphor layer 29 may be formed by applying a phosphor material on the front substrate 20 having the front-plate barrier rib 26, or it may be formed by etching the front substrate 20 into the shape of the front discharge spaces 28 and by applying a phosphor material on the etched surface.

When the rear substrate 10 is etched to form the rear-plate barrier ribs 16, the rear substrate 10 and the rear-plate barrier ribs 16 are made of the same material. When the front substrate 20 is etched to form the front-plate barrier ribs 26, the front substrate 20 and the front-plate barrier ribs 26 are made of the same material. This etching method can reduce manufacturing costs, compared to a method in which the rear-plate barrier ribs 16 and the front-plate barrier ribs 26 are formed separately from the rear and front substrates 10, 20 and attached to these substrates at a later stage.

The first phosphor layer 19 absorbs vacuum ultraviolet rays to generate visible light emitted to the front substrate 20 in the back discharge spaces 18 on the rear substrate 10. The second phosphor layer 29 absorbs vacuum ultraviolet rays to generate visible light emitted to the front substrate 20 in the front discharge spaces 28 on the front substrate 20. In addition, the first phosphor layer 19 reflects visible light, and the second phosphor layer 29 transmits the visible light. Therefore, in some embodiments, a thickness t₁ of the first phosphor layer 19 which is formed on the rear substrate 10 may be larger than a thickness t₂ of the second phosphor layer 29 which is formed on the front substrate 20 (t₁>t₂). This structure improves the luminescence efficiency of visible light emitted to the front substrate 20.

Vacuum ultraviolet rays collide with the first and second phosphor layers 19, 29 having the above-mentioned structure. In order to generate the vacuum ultraviolet rays by a plasma discharge to form an image, address electrodes 12, first electrodes 31 (hereinafter, referred to as “sustain electrodes”), and second electrodes 32 (hereinafter, referred to as “scan electrodes”), which correspond to the discharge cells 17, are provided between the rear substrate 10 and the front substrate 20.

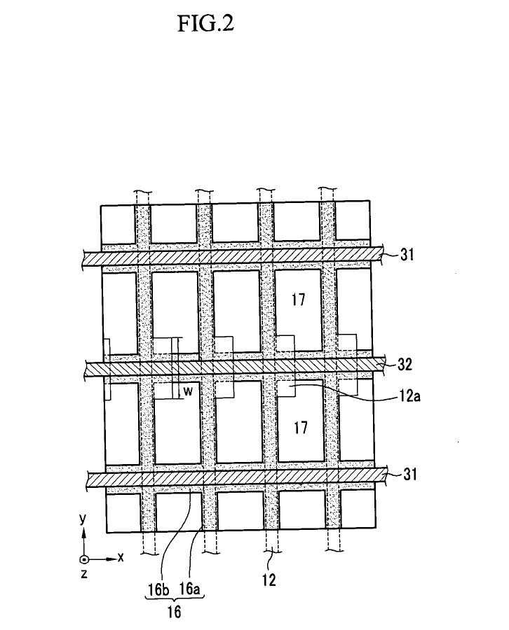

FIG. 2 is a partial plan view schematically illustrating the structure of discharge cells and electrodes of the PDP of FIG. 1. The address electrodes 12 extend in a direction (y-axis direction) orthogonal to the sustain electrodes 31 and the scan electrodes 32. The address, sustain, and scan electrodes, 12, 31, 32 are all located between the rear-plate barriers ribs 16 and the front-plate barrier ribs 26. The address electrodes 12 have protruding portions 12a projecting in the x-axis direction. The protruding portion 12a is commonly used by the back discharge spaces 18 that are adjacent along the direction of the address electrode 12 (y-axis direction). As a result, adjacent discharge cells 17 can be addressed simultaneously. The protruding portion 12a can be shared by adjacent discharge cells 17 sharing the same sustain electrode 31 or by adjacent discharge cells 17 sharing the same scan electrode 32. For example, the address electrode 12 and the scan electrode 32 participate in the addressing of discharge cells adjacent to each other along the direction of the address electrode 12 (y-axis direction). In addition, because the protruding portion 12a is provided in adjacent discharge cells 17 that are on the rear substrate 10, the shielding of visible rays by the protruding portion 12a is reduced, resulting in an improvement in luminescence efficiency.

The sustain electrodes 31 and the scan electrodes 32 are arranged between the rear-plate barrier ribs 16 and the front-plate barrier ribs 26, and extend parallel to each other. In FIG. 2, the sustain electrodes 31 and the scan electrodes 32 are alternately arranged adjacent to one another along the x-axis direction on both sides of the discharge cells 17 and are shared by their adjacent discharge cells 17. Therefore, the sustain electrodes 31 and the scan electrodes 32 participate in a sustain discharge of the adjacent discharge cells 17 located between them. Thus, in the PDP having the above-mentioned structure, the sustain electrodes 31 are divided into even-numbered sustain electrodes and odd-numbered sustain electrodes, and the scan electrodes 32 are also divided into even-numbered scan electrodes and odd-numbered scan electrodes. When a sustain discharge is performed on the even-numbered electrodes, sustain pulses are applied to the even-numbered sustain and scan electrodes 31, 32. On the other hand, when a sustain discharge is performed on the odd-numbered electrodes, sustain pulses are applied to the odd-numbered sustain and scan electrodes 31, 32, thereby displaying an image.

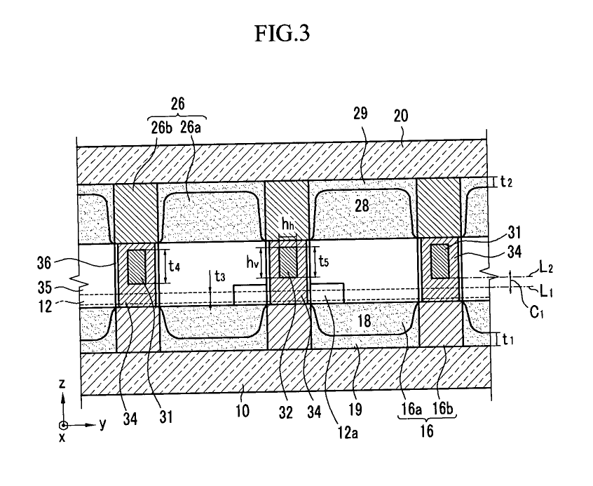

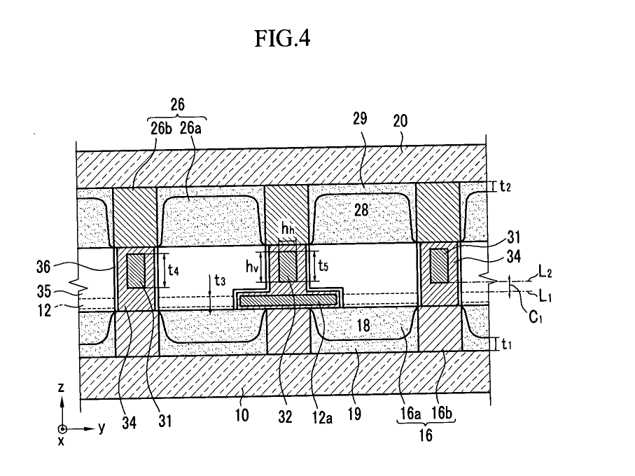

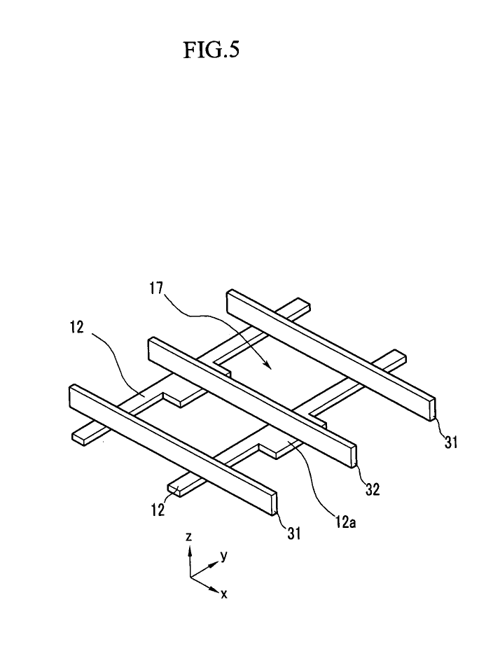

FIG. 3 is a cross-sectional view taken along the line III-III of the PDP formed by combining the front substrate 20 with the rear substrate 10 shown in FIG. 1. FIG. 4 is a cross-sectional view taken along the line IV-IV of the PDP shown in FIG. 1. FIG. 5 is a partial perspective view schematically illustrating the structure of address, sustain, and scan electrodes 12, 31, 32 of a PDP according to an embodiment of the invention.

Referring to these figures, the address electrodes 12 extend in the y-axis direction between the rear-plate barrier ribs 16 and the front-plate barrier ribs 26. In the z-axis direction, the address electrodes 12 are located between the rear substrate 10 and the front substrate 20. The address electrodes 12 are formed between the first barrier rib members 16a and the third barrier rib members 26a extending in the y-axis direction and are parallel to the first and third barrier rib members 16a, 26a. In addition, the address electrodes 12 are located or formed parallel to one another at intervals along the x-axis direction corresponding to the discharge cells 17.

The protruding portion 12a protrudes from the address electrodes 12 in the x-axis direction. The protruding portion 12a has a predetermined width w (shown on FIG. 2) along the y-axis direction. The width w is shared by adjacent discharge cells 17 that use a common scan electrode 32. A part of the protruding portion 12a corresponds to the scan electrode 32 extending in the x-axis direction. From this part, the protruding portion 12a protrudes in the y-axis direction into adjacent discharge cells 17.

When scan and address pulses are respectively applied to the scan and address electrodes 32, 12, an address discharge occurs in discharge cells 17. The scan and address electrodes 32, 12 that are commonly used by adjacent discharge cells 17 are formed such that the protruding portions 12a correspond to both scan and address electrodes 32, 12. The protruding portions 12a cause the address pulses applied to the address electrodes 12 to be supplied to the discharge cells 17. Further, as a result of these protruding portions 12a, a discharge gap between the protruding portion 12a and the scan electrode 32 is a short gap. A short gap requires a lower address discharge voltage. In the embodiment shown, each address electrode 12 is provided between adjacent discharge cells 17 along the y-axis direction. Each address electrode 12 is also located between the first and third barrier rib members 16a, 26a. The address electrodes 12, that run along the y-axis, can be used for dividing the discharge cells 17 along the x-axis direction.

Further, the sustain and scan electrodes 31, 32 extend in the x-axis direction of the figures, orthogonal to the address electrodes 12. In the z-axis direction, the sustain and scan electrodes 31, 32 are located between the rear-plate barrier rib 16 and the front-plate barrier rib 26. In addition, the sustain and scan electrodes 31, 32 are electrically isolated from the address electrodes 12. That is, the sustain and scan electrodes 31, 32 are formed between the second and fourth barrier rib members 16b, 26b an parallel to these barrier rib members 16b, 26b. The sustain and scan electrodes 31, 32 are alternately arranged and are commonly used by the discharge cells 17 adjacent to one another across the direction of the address electrodes 12.

In this embodiment, because the sustain and scan electrodes 31, 32 are alternately arranged with respect to adjacent discharge cells 17 between the second and fourth barrier rib members 16b, 26b, the sustain and scan electrodes 31, 32 can be standards for dividing the discharge cells 17 along the lengthwise direction of the address electrodes 12.

During an address period, the scan electrode 32 and the address electrode 12 create an address discharge to select the discharge cells 17 to be turned on. During a sustain period, the sustain and scan electrodes 31, 32 create a sustain discharge to display an image. Sustain pulses are applied to the sustain electrodes 31 during the sustain period. In addition, the sustain pulses may be applied to the scan electrodes 32 during the sustain period, and scan pulses may also be applied to the scan electrodes 32 during a scan period. The respective electrodes may perform different functions according to signal voltages applied to them. The invention is therefore not limited to the structure shown.

The sustain and scan electrodes 31, 32 are located between the two substrates 10, 20, thereby partitioning the space between the substrates 10, 20 into the discharge cells 17. The two portions of the each discharge cell 17 together form one discharge cell 17. An opposing electrode structure formed in this way can reduce a discharge firing voltage of a sustain discharge more than a surface discharge structure, and can improve the luminescence efficiency more than the surface discharge structure.

Further, in order to increase the area of each discharge cell 17, the sustain and scan electrodes 31, 32 may be formed with a height hᵥ in the z-axis direction larger than a width hₕ in the y-axis direction. The discharge occurring in a larger discharge cell 17 generates high-intensity vacuum ultraviolet rays. The high-intensity vacuum ultraviolet rays collide with the phosphor layers 19, 29 formed over the large area of the discharge cell 17. As a result, a larger amount of visible light is generated.

The address electrodes 12 are arranged close to the rear substrate 10, and the sustain and scan electrodes 31, 32 are arranged close to the front substrate 20. A gap C₁ exists between an imaginary line L₁ formed by an extension of an edge of the address electrode 12 facing the front substrate 20 and an imaginary line L₂ formed by an extension of an edge of the sustain or scan electrodes 31, 32 facing the rear substrate 10. This gap C1 allows the sustain and scan electrodes 31, 32 and the address electrodes 12 to cross paths without actually intersecting.

Furthermore, in the direction perpendicular to the rear substrate 10 and the front substrate 20, a thickness t₃ of the address electrode is smaller than a thickness t₄ of the sustain electrode 31 and a thickness t₅ of the scan electrode 32. This structure enables sustain pulses having a higher voltage than the address pulses applied to the address electrodes 12 to be stably applied to the sustain and scan electrodes 31, 32.

It is possible to form the sustain electrodes 31, the scan electrodes 32, and the address electrodes 12 from metal having high conductivity because these electrodes are located in a non-emission region between the rear-plate barrier rib 16 and the front-plate barrier rib 26.

Dielectric layers 34, 35 are formed on outer surfaces of the sustain, scan and address electrodes 31, 32, 12. The dielectric layers 34, 35 not only store wall charges, but also insulate the electrodes 31, 32, 12 from one another. The sustain, scan and address electrodes 31, 32, 12 can be formed by a thick film ceramic sheet (TFCS) method. In the TFCS method, an electrode unit, such as the sustain, scan and address electrodes 31, 32, 12, is manufactured separately, and is then bonded to the rear substrate 10 that includes the rear-plate barrier rib 16.

A protective film 36 may be formed on the dielectric layers 34, 35 covering the sustain, scan, and address electrodes 31, 32, 12. In particular, the protective film 36 may be formed to be exposed to the plasma discharge occurring in the discharge spaces of the discharge cells 17. The protective film 36 protects the dielectric layers 34, 35 and requires a high secondary electron emission coefficient. However, the protective film 36 does not need to have the property of transmitting visible light. Because the sustain, scan, and address electrodes 31, 32, 12 are not located on either of the front or rear substrates 20, 10, but are rather located between the two, the protective film 36 formed on the dielectric layers 34, 35 that cover the sustain, scan, and address electrodes 31, 32, 12 may be made of a material having a non-visible-light-transmittance characteristic. An MgO film may be used, as an example of a non-visible-light-transmitting protective film 36. An MgO film has a very high secondary electron emission coefficient and makes it possible to further reduce a discharge firing voltage.

Furthermore, the address electrodes 12 are surrounded by the dielectric layer 35 having the same dielectric constant throughout. Therefore, the same discharge firing voltage is formed among red (R), green (G), and blue (B) phosphor layers 19, 29.

Although the present invention has been described with reference to certain exemplary embodiments, it will be understood by those skilled in the art that a variety of modifications and variations may be made to the present invention without departing from the spirit or scope of the present invention defined in the appended claims, and their equivalents.

What is claimed is:

1. A plasma display panel comprising:
a first substrate;
a second substrate spaced apart from the first substrate;
a plurality of partitioned discharge cells being formed between the first substrate and the second substrate;
address electrodes extending along a first direction between the first substrate and the second substrate and parallel to them;
first electrodes and second electrodes extending along a second direction between the first substrate and the second substrate and parallel to them, the second direction crossing the first direction, the first electrodes and the second electrodes being separated from the address electrodes; and
protruding portions protruding from each of the address electrodes along the second direction toward partitioned discharge cells, each protruding portion extending into a pair of adjacent discharge cells, the pair of adjacent discharge cells sharing each protruding portion of the address electrode and either one of the first electrodes or one of the second electrodes.

2. The plasma display panel of claim 1, further comprising:
a first barrier rib layer located on the first substrate forming a plurality of first discharge spaces; and
a second barrier rib layer located on the second substrate forming a plurality of second discharge spaces corresponding to the first discharge spaces,
wherein each of the partitioned discharge cells is defined by a pair of one first discharge space and one second discharge space opposite each other.

3. The plasma display panel of claim 2, wherein the address electrodes, the first electrodes, and the second electrodes are located between the first barrier rib layer and the second barrier rib layer.

4. The plasma display panel of claim 2, wherein a volume of each second discharge space is larger than a volume of each first discharge space.

5. The plasma display panel of claim 2,
wherein the first barrier rib layer includes first barrier rib members that extend in the first direction, and
wherein the second barrier rib layer includes second barrier rib members that extend in the first direction.

6. The plasma display panel of claim 5,
wherein the first barrier rib layer further includes third barrier rib members that intersect the first barrier rib members, and
wherein the second barrier rib layer further includes fourth barrier rib members that intersect the second barrier rib members.

7. The plasma display panel of claim 1, wherein the first and second electrodes are composed of metal electrodes.

8. The plasma display panel of claim 1, wherein the first electrodes, the second electrodes, and the address electrodes have dielectric layers on outer surfaces.

9. The plasma display panel of claim 8, wherein a protective film is formed on the dielectric layers.

10. The plasma display panel of claim 9, wherein the protective film has non-visible-light-transmission characteristic.

11. The plasma display panel of claim 9, wherein the protective film is formed from magnesium oxide (MgO).

12. The plasma display panel of claim 1,
wherein the address electrodes are located closer to the first substrate than the second substrate and are facing the second substrate,
wherein the first and second electrodes are located closer to the second substrate than the first substrate and are facing the first substrate, and
wherein a gap is formed between a side of the address electrode facing the second substrate and a side of each of the first electrodes and the second electrodes facing the first substrate.

13. The plasma display panel of claim 1, wherein a thickness of the address electrode is smaller than a thickness of the first electrode, thicknesses measured along a direction perpendicular to the first and the second substrate.

14. The plasma display panel of claim 1, wherein a thickness of the address electrode is smaller than a thickness of the second electrode, thicknesses measured along a direction perpendicular to the first and the second substrate.

15. The plasma display panel of claim 1, further comprising:
a first phosphor layer formed on the first substrate in the discharge cells; and
a second phosphor layer having a same color as the first phosphor layer and is formed on the second substrate in the discharge cells.

16. The plasma display panel of claim 15, wherein a thickness of the first phosphor layer is larger than a thickness of the second phosphor layer.

17. The plasma display panel of claim 1,
wherein scanning pulses are applied to the first electrodes during an addressing period, and
wherein the protruding portions cross boundaries between adjacent discharge cells formed by the first electrodes.

18. The plasma display panel of claim 1,
wherein scanning pulses are applied to the second electrodes during an addressing period, and
wherein the protruding portions cross boundaries between adjacent discharge cells formed by the second electrodes.
